(19) United States
(12) Patent Application Publication
(10) Pub. No.: US 2026/0217978 A1
(43) Pub. Date: Jul. 30, 2026

(54) VULCANIZATION-ACTIVATING COMPOSITION, METHOD FOR PRODUCING SAME AND USE THEREOF

(71) Applicant: SILOX BELGIUM, ENGIS (BE)

(72) Inventors: Olivier ROUMACHE, ENGIS (BE); Mathurin GROGNA, ENGIS (BE)

(21) Appl. No.: 19/144,737

(22) PCT Filed: Dec. 27, 2023
(86) PCT No.: PCT/EP2023/087858

§ 371 Date: Jun. 30, 2025

(30) Foreign Application Priority Data
Dec. 29, 2022 (BE) BE2022/6113

(51) Int. Cl. C08L 91/00; C08K 3/04; C08K 3/06; C08K 3/22; C08K 3/26; C08K 3/30; C08K 5/01; C08K 5/08; C08K 5/09; C08K 5/17; C08K 5/435

(52) U.S. Cl. CPC C08L 91/00; C08K 3/04; C08K 3/06; C08K 3/22; C08K 3/26; C08K 3/30; C08K 5/01; C08K 5/08; C08K 5/09; C08K 5/17; C08K 5/435; C08K 2003/222; C08K 2003/2296; C08K 2003/265; C08K 2003/3009

(57) ABSTRACT

The present disclosure relates to a method for preparing a vulcanization-activating composition, the process comprising at least one step of mixing at least 5% by weight and at most 75% by weight of particles of a oxygenated zinc compound, and at least 1% by weight and at most 75% by weight of at least one vegetable oil or at least one vegetable oil derivative, thereby forming the composition (A). The vegetable oil or vegetable oil derivative comprises, based on the total weight of said vegetable oil or vegetable oil derivative, at least 8% by weight of at least one fatty acid residue, wherein the fatty acid residue comprises at least two unsaturations.

### FIELD OF THE INVENTION

This invention relates to the field of methods for preparing a vulcanization-activating composition based on vegetable oil or vegetable oil derivative(s).

### PRIOR ART

Vulcanisation is a cross-linking reaction that occurs when a vulcanisable polymer is exposed to a vulcanising agent (usually sulphur) and heat energy. The latter is necessary for the establishment of chemical bonds between the vulcanising agent and the reactive sites of the polymer molecular chains, thus forming a three-dimensional network.

Once the polymer has been vulcanised, it has specific mechanical and elastic properties that make it suitable for use in a variety of applications, such as tyres.

In order to activate the vulcanisation reaction between the polymer and the vulcanising agent, it is known to use a vulcanisation activator such as a divalent metal oxygen compound, the most commonly used of which is the zinc oxide, ZnO.

Vulcanization-activating compositions are already known to those skilled in the art. Mention may be made of EP 3896129 A1, which discloses a composition comprising from 20 to 80% by weight of at least one vulcanisation activator, from 10 to 40% by weight of at least one wax chosen from the group consisting of paraffin-based waxes, microcrystalline waxes, polyolefin waxes, Fischer-Tropsch waxes, oxidized Fischer-Tropsch waxes, their derivatives and mixtures thereof, from 10 to 40% by weight of at least one inorganic filler or carbon black.

When these compositions are used in a vulcanisation method, for example in the vulcanisation of rubber, the ZnO and the other compounds in the activating composition will be found at least in part (or totally) inside the vulcanised rubber. Unfortunately, ZnO is known to migrate out of the rubber and contaminate the environment. This is the case, for example, if the vulcanised rubber comes into prolonged contact with water. It has been observed that at least some of the ZnO can migrate out of the rubber and contaminate the water in direct contact with it. ZnO is known to be ecotoxic. It is therefore necessary to develop vulcanization-activating compositions that reduce the amount of ZnO released into the environment by the vulcanised rubber, or at least release only a small amount of ZnO.

In addition, the waxes usually used, such as paraffin waxes, microcrystalline waxes, polyolefin waxes and Fischer-Tropsch waxes, are synthetic waxes. Generally speaking, industry is seeking to reduce the ecological footprint of its production methods. There is therefore a need to reduce the use of synthetic material in vulcanization-activating compositions.

### SUMMARY OF THE INVENTION

Surprisingly, the inventors found that the composition according to the invention made it possible, among other things, to solve the problems identified above.

The present invention relates to a method for preparing a vulcanization-activating composition [hereinafter, composition (A)], said method comprising at least one mixing step:
of at least 5% by weight and at most 95% by weight, preferably at least 5% by weight and at most 75% by weight, of particles of an oxygenated zinc compound [hereinafter compound (OZ)], and
of at least 1% by weight and at most 75% by weight of at least one vegetable oil or of at least one vegetable oil derivative, thus forming the composition (A), the % by weight being based on the total weight of said composition (A);
wherein said vegetable oil or vegetable oil derivative comprises, based on the total weight of said vegetable oil or vegetable oil derivative: at least 8% by weight of at least one fatty acid residue; said fatty acid residue comprising at least two unsaturations.

The present invention also relates to a vulcanization-activating composition obtained by the above method.

The present invention also relates to the use of a vulcanization-activating composition obtained by the above method in a vulcanisation method.

### DETAILED DESCRIPTION

According to the present invention, the term “comprising” is inclusive and open-ended and does not exclude the addition of elements not listed, compositions or method steps.

In the context of the present invention, if it is stated that an element or component is selected from a list of named elements or components, it is to be understood that the element or component may also be any of the individual elements or components named in said list, or may also be selected from a group consisting of two or more of the explicitly listed elements or components.

### Composition (A)

As explained above, the present invention relates to an activating composition [composition (A)] for use in a vulcanisation method.

Vulcanization methods are known to those skilled in the art. In general, a vulcanization reaction is a chemical cross-linking reaction that occurs when a vulcanizable polymer (such as natural rubber) is brought into contact with a vulcanising agent (usually sulphur) and thermal energy.

Preferably, said composition (A) is suitable for use in a vulcanizing method a vulcanizable composition [composition (C)] comprising a polymer (V) when less than 10 parts by weight, more preferably less than 8 parts by weight, still more preferably less than 6 parts by weight of said composition (A) are included in the composition (C) relative to 100 parts by weight of the polymer (V).

### Said Mixing

Said method according to the invention comprises at least one mixing step:
of at least 5% by weight and up to 95% by weight, preferably at least 5% by weight and up to 75% by weight, of particles of an oxygenated zinc compound [hereinafter compound (OZ)], and
of at least 1% by weight and at most 75% by weight of at least one vegetable oil or of at least one vegetable oil derivative, thus forming the composition (A), based on the total weight of said composition (A).

Said mixing can be carried out by any means known to those skilled in the art for producing vulcanization-activating compositions. In particular, said mixing may, for example, be carried out in a mixer, blender or any other machine for mixing said compound (OZ) and the vegetable oil or the derivative of a vegetable oil.

Preferably, the mixing is carried out at a temperature and for a duration which prevent a significant part of the compound (OZ) and of the vegetable oil or of the derivative of a vegetable oil from reacting or degrading, while making it possible to obtain a homogeneous mixture of said compound (OZ) and of the vegetable oil or of said derivative of a vegetable oil. Said temperature and said mixing time prevent, for example, a significant proportion of the unsaturations in said vegetable oil or vegetable oil derivative from reacting or degrading.

Preferably, the mixing is produced at a temperature of at most 100° C., more preferably of at most 80° C., even more preferably of at most 70° C., even more preferably of at most 60° C., even more preferably of at most 50° C., even more preferably of at most 40° C. This has the effect of reducing or avoiding reactions between the natural oil and said compound (OZ), such as the formation of complexes between zinc and fatty acids, or avoiding degradation reactions and of said vegetable oil or said derivative of a vegetable oil.

The mixing can be made at a temperature of preferably at least 10° C., more preferably of at least 15° C., more preferably of at least 17° C., more preferably of at least 20° C.

In a preferred embodiment, said mixing is carried out at a temperature of at least 10° C. and at most 40° C., more preferably at least 15° C. and at most 40° C., more preferably at least 17° C. and at most 40° C., more preferably at least 20° C. and at most 40° C.

Preferably, said mixing is carried out for no more than 30 minutes, or no more than 20 minutes, or no more than 10 minutes, or no more than 5 minutes, or no more than 1 minute or no more than 30 seconds.

Preferably, during said mixing, the temperature is controlled by at least one thermocouple.

Depending on the quantity of said compound (OZ) and the vegetable oil or the derivative of a vegetable oil, said compound (A) may be a pulverulent composition of particles of compound (OZ) at least partially coated with vegetable oil or the derivative of a vegetable oil or said composition (A) may be a pasty or liquid composition.

In a preferred embodiment, said composition (A) is a powder composition of at least partially coated OZ compound particles, said method comprising at least one mixing step:
of at least 20% by weight and at most 60% by weight of particles of a compound (OZ), and
of at least 1% by weight and at most 35% by weight of at least one vegetable oil or of at least one vegetable oil derivative, thus forming the composition (A), based on the total weight of said composition (A).

In this embodiment, said composition (A) has a D50 of at least 1 μm, preferably at least 2 μm, more preferably at least 3 μm. Preferably, said composition (A) has a D50 of at most 20 μm, more preferably of at most 15 μm.

In this embodiment, said composition (A) preferably has a D50 of at least 1 μm and of at most 20 μm, more preferably of at least 2 μm and of at most 15 μm.

In a preferred embodiment, at most 70% by weight, preferably at most 68% by weight of said particles of a compound (OZ), based on the total weight of said composition (A), are mixed in the mixing step.

Preferably, at least 25% by weight, more preferably at least 30% by weight, of said at least one vegetable oil or said at least one vegetable oil derivative, based on the total weight of said composition (A), is mixed in the mixing step. \

In another preferred embodiment, said composition (A) is a pasty or liquid composition, said method comprising at least one mixing step:
of at least 20% by weight and at most 60% by weight of particles of a compound (OZ), and
of at least 15% by weight and at most 75% by weight of at least one vegetable oil or of at least one vegetable oil derivative, thus forming the composition (A), based on the total weight of said composition (A).

In this embodiment, at most 50% by weight, preferably at most 40% by weight of particles of a compound (OZ), based on the total weight of said composition (A), are mixed in the mixing step.

In this same embodiment, preferably at most 65% by weight, more preferably at most 55% by weight, even more preferably at most 45% by weight, even more preferably at most 40% by weight of said at least one vegetable oil or of said at least one derivative of a vegetable oil, based on the total weight of said composition (A), are mixed in the mixing step.

In this same embodiment, preferably at least 20% by weight, more preferably at least 25% by weight of said at least one vegetable oil or said at least one vegetable oil derivative, based on the total weight of said composition (A), are mixed in the mixing step.

### The Compound (OZ)

In the context of the present invention, “oxygenated zinc compound” can be defined as a compound comprising a zinc atom and an oxygen atom. In particular, said compound (OZ) is a vulcanisation activator. In particular, said oxygenated zinc compound may be selected from the group consisting of zinc oxide, zinc hydroxide, zinc carbonate, zinc hydroxycarbonate and mixtures or derivatives thereof, preferably the oxygenated zinc compound is zinc oxide (ZnO).

Preferably, said method comprises mixing at least 10% by weight of said compound (OZ), more preferably at least 12% by weight, more preferably at least 15% by weight, more preferably at least 20% by weight, more preferably at least 25% by weight, more preferably at least 30% by weight, more preferably at least 40% by weight, more preferably at least 50% by weight, more preferably at least 60% by weight of said compound (OZ) based on the total weight of said composition (A).

Preferably, said method comprises mixing at most 70% by weight of said compound (OZ), more preferably at most 65% by weight, more preferably at most 55% by weight, more preferably at most 50% by weight, more preferably at most 45% by weight, more preferably at most 40% by weight, more preferably at most 35% by weight of said compound (OZ) based on the total weight of said composition (A).

In a preferred embodiment, the mixture of at least 10% by weight and at most 70% by weight, preferably at least 12% by weight and at most 65% by weight, more preferably at least 15% by weight and at most 60% by weight, more preferably at least 15% by weight and at most 55% by weight, more preferably at least 15% by weight and at most 50% by weight of said compound (OZ) based on the total weight of said composition (A).

Preferably, said compound (OZ) has a D50 of at least 100 nm, more preferably of at least 200 nm, even more preferably of at least 300 nm, even more preferably of at least 400 nm, even more preferably of at least 500 nm, even more preferably of at least 600 nm, even more preferably of at least 700 nm, even more preferably of at least 800 nm, even more preferably of at least 1 μm, even more preferably of at least 2 μm.

If desired, said compound (OZ) may have a D50 of at most 500 μm, or of at most 100 μm, or of at most 20 μm or of at most 15 μm.

In a preferred embodiment, said compound (OZ) has a D50 of at least 100 nm and of at most 500 μm, preferably of at least 300 nm and of at most 100 μm, more preferably of at least 500 nm and of at most 20 μm, even more preferably of at least 1 μm and of at most 20 μm.

In the context of the present invention, the notation Dx represents a diameter, expressed in μm, in relation to which X % by volume of the total volume of particles measured is made up of smaller particles. In the framework of the present invention, all D50 particle size measurements are laser particle size measurements carried out in water.

In the framework of the present invention, all the BET specific surface area values of any products such as coated particles or any given compound are measured by adsorption manometry of a mixture of nitrogen and helium gas and calculated according to the BET method, after degassing under vacuum at 50° C. for at least 1 hour.

If desired, said OZ compound may have a BET surface area of at least 1 m²/g, preferably at least 2 m²/g.

If desired, said OZ compound can have a BET surface area of at most 100 m²/g, preferably at most 60 m²/g.

In a preferred embodiment, said OZ compound has a BET surface area of at least 1 m²/g and at most 100 m²/g, preferably at least 2 m²/g and at most 60 m²/g.

If desired, said OZ compound has a D50 measured by laser granulometry in methanol, after ultrasonic treatment for 3 minutes, of at least 0.25 μm, preferably at least 3 μm, more preferably at least 5 μm.

If desired, said OZ compound has a D50 measured by laser granulometry in water, after ultrasonic treatment for 3 minutes, of at most 5000 μm, preferably at most 4000 μm, more preferably at most 3000 μm; at most 100 μm, at most 50 μm, at most 10 μm; at most 7 μm.

In one embodiment, said OZ compound has a D50 measured by laser granulometry in methanol, after a 3-minute ultrasonic treatment, of at least 0.25 μm and at most 4000 μm, at least 3 μm and at most 3000 μm, more preferably at least 5 μm and at most 100 μm, even more preferably at least 5 μm and at most 50 μm, even more preferably at least 5 μm and at most 10 μm, even more preferably at least 5 μm and at most 7 μm.

### Said Natural Oil

In the context of the present invention, the term “vegetable oil” takes on its usual meaning known to those skilled in the art. In general, a vegetable oil is an oil derived from a plant or part of a plant, such as the seeds. Vegetable oils which may be used in the framework of the present invention include for example (but are not limited to): linseed oil, walnut oil, sunflower oil, corn oil, avocado oil, hemp oil, grapeseed oil, olive oil, peanut oil, rice oil, sesame oil, soya oil, rapeseed oil, safflower oil, wheat germ oil and mixtures thereof.

In the framework of the present invention, the term “vegetable oil derivative” covers, for example, at least partially polymerised vegetable oils, partially polymerised oils, dehydrogenated vegetable oils, vegetable oils that have undergone ageing treatment, heat treatment or chemical treatment, and mixtures thereof. A vegetable oil derivative can therefore comprise stand oil, raw oil and boiled oil.

Examples of vegetable oil derivatives comprise (but are not limited to): aged linseed oil, partially polymerised linseed oil, cooked linseed oil, dehydrogenated palm oil and mixtures thereof.

Examples of vegetable oil derivatives comprise linseed oil, walnut oil, sunflower oil, corn oil, avocado oil, hemp oil and grapeseed oil, olive oil, peanut oil, rice oil, sesame oil, soya oil, rapeseed oil, safflower oil, wheat germ oil, palm oil and mixtures thereof.

Using vegetable oil or a derivative of vegetable oil is advantageous because it is a bio-sourced material.

According to the invention, said vegetable oil or vegetable oil derivative comprises, based on the total weight of said vegetable oil or vegetable oil derivative: at least 8% by weight of at least one fatty acid residue.

In the framework of the present invention, the term “fatty acid residue” takes on its usual meaning known to those skilled in the art. For example, the fatty acid residue may form part of a fat and be at least partly in the form of a triglyceride, a diglyceride and/or a monoglyceride. The fatty acid residue may also be at least partly in the form of free fatty acid, i.e. not in the form of a glyceride. The free fatty acid may be in protonated or at least partially deprotonated form.

The fatty acid residue can be linear or branched.

Examples of fatty acid residues that may be used include (but are not limited to): linoleic acid, α-linolenic acid, γ-linolenic acid, dihomo-γ-linolenic acid, arachidonic acid, eicosapentaenoic acid and docosahexaenoic acid residues.

According to the invention, said fatty acid residue comprises at least 2 unsaturations, preferably at least 3 unsaturations.

Surprisingly, the inventors noticed that the use of the composition (A) according to the invention in a vulcanisation method made it possible to reduce or, in some cases, avoid the release of zinc from compound (OZ) (or of zinc) outside the vulcanised polymer.

Without wishing to be bound by any theory, the inventors believe that at least some of the unsaturations included in said vegetable oil or said vegetable oil derivative would react during the vulcanisation. As a result, at least some of the unsaturated fatty acid residues would be incorporated into the vulcanised polymer by cross-linking. This incorporation is more important or more likely when the fatty acid residue carries at least two unsaturations. In addition, it would appear that after vulcanisation, some of the unsaturated fatty acid residues are no longer in the form of glycerides but in the form of fatty acids whose carboxylic acid functions (in the form of carboxylates) at least partially complex the zinc. The complexation of zinc by fatty acid residues trapped in the vulcanised polymer matrix would enable at least some or all of the zinc in compound (OZ) to be retained.

In addition, it was surprising to find that the properties of vulcanised polymers were not significantly affected by the presence of the vegetable oil.

In addition, the inventors noticed that the compositions in which the vegetable oil was present in the composition according to the invention had an advantageously lower angle of repose than for compositions comprising only an OZ compound, which indicates that the composition flows in a fluid manner.

The unsaturation of said fatty acid residue may be cis or trans.

Preferably, the unsaturations of said fatty acid residue are separated by at least one —CH₂— function, more preferably by only one —CH₂— function.

Preferably, said fatty acid residue is C12-C30, more preferably C14-C28, more preferably C14-C26, even more preferably C14-C24, more preferably C16-C24, more preferably C16-C22, more preferably C16-C20, even more preferably C18.

Preferably, said vegetable oil and/or said vegetable oil derivative comprises at least 15% by weight of said fatty acid residue, more preferably at least 20% by weight of said fatty acid residue, even more preferably at least 25% by weight of said fatty acid residue, more preferably at least 30% by weight of said fatty acid residue, more preferably at least 35% by weight of said fatty acid residue, even more preferably at least 40% by weight of said fatty acid residue, even more preferably at least 50% by weight of said fatty acid residue, based on the total weight of said vegetable oil or said vegetable oil derivative.

Preferably, said vegetable oil and/or said vegetable oil derivative comprises at most 80% by weight of said fatty acid residue, more preferably at most 75% by weight of said fatty acid residue, even more preferably at most 70% by weight of said fatty acid residue, based on the total weight of said vegetable oil or said vegetable oil derivative.

In a preferred embodiment, said vegetable oil and/or said vegetable oil derivative comprises at least 15% by weight and at most 80% by weight of said fatty acid residue, more preferably at least 20% by weight and at most 80% by weight of said fatty acid residue, even more preferably at least 25% by weight and at most 75% by weight of said fatty acid residue, more preferably at least 30% by weight and at most 70% by weight of said fatty acid residue, more preferably at least 35% by weight and at most 70% by weight of said fatty acid residue, even more preferably at least 40% by weight and at most 70% by weight of said fatty acid residue, even more preferably at least 50% by weight and at most 70% by weight of said fatty acid residue, based on the total weight of said vegetable oil or said vegetable oil derivative.

In a preferred embodiment, said vegetable oil and/or said vegetable oil derivative comprises a fatty acid residue (A) comprising two unsaturations and a fatty acid residue (B) comprising at least three unsaturations. The fatty acid residue (A) may be a linoleic acid residue. The fatty acid residue (B) may be a residue of α-linolenic acid, γ-linolenic acid, dihomo-γ-linolenic acid, arachidonic acid, eicosapentaenoic acid or docosahexaenoic acid.

Preferably, the unsaturations of said fatty acid residues (A) and (B) are separated by at least one —CH₂— function, more preferably by only one —CH₂— function.

Preferably, each fatty acid residue is C12-C30, more preferably C14-C28, more preferably C14-C26, even more preferably C14-C24, more preferably C16-C24, more preferably C16-C22, more preferably C16-C20, even more preferably C18.

Preferably, said vegetable oil and/or said vegetable oil derivative comprises at least 8% by weight, more preferably at least 10% by weight of said fatty acid residue (A), based on the total weight of said vegetable oil or said vegetable oil derivative.

Preferably, said vegetable oil and/or said vegetable oil derivative comprises at most 30% by weight, more preferably at most 25% by weight, even more preferably at most 20% by weight of said fatty acid residue (A), based on the total weight of said vegetable oil or said vegetable oil derivative.

In a preferred embodiment, said vegetable oil and/or said vegetable oil derivative comprises at least 8% by weight and at most 30% by weight, more preferably at least 10% by weight and at most 25% by weight, even more preferably at least 10% by weight and at most 20% by weight of said fatty acid residue (A), based on the total weight of said vegetable oil or said vegetable oil derivative.

Preferably, said vegetable oil and/or said vegetable oil derivative comprises at least 30% by weight, more preferably at least 35% by weight, even more preferably at least 40% by weight of said fatty acid residue (B), based on the total weight of said vegetable oil or said vegetable oil derivative.

Preferably, said vegetable oil and/or said vegetable oil derivative comprises at most 75% by weight, more preferably at most 70% by weight, even more preferably at most 65% by weight of said fatty acid residue (B), based on the total weight of said vegetable oil or said vegetable oil derivative.

In a preferred embodiment, said vegetable oil and/or said vegetable oil derivative comprises at least 30% by weight and at most 75% by weight, more preferably at least 35% by weight and at most 70% by weight, even more preferably at least 10% by weight and at most 65% by weight of said fatty acid residue (B), based on the total weight of said vegetable oil or said vegetable oil derivative.

In a preferred embodiment, said vegetable oil and/or said vegetable oil derivative comprises at least 10% by weight and at most 20% by weight of said fatty acid residue (A) and at least 10% by weight and at most 65% by weight of said fatty acid residue (B), based on the total weight of said vegetable oil or said vegetable oil derivative; said fatty acid residue (A) being a C16-C22 residue comprising at least two unsaturations separated by a —CH₂— group; said fatty acid residue (B) being a C16-C22 residue comprising at least three unsaturations separated by a —CH₂— group.

In an even more preferred embodiment, said vegetable oil is linseed oil, said linseed oil comprising at least 10% by weight and at most 20% by weight of said fatty acid residue (A) and at least 10% by weight and at most 65% by weight of said fatty acid residue (B); said fatty acid (A) being linoleic acid and said fatty acid (B) being α-linolenic acid.

Preferably, said vegetable oil and/or said vegetable oil derivative comprises at least one fatty acid residue comprising an unsaturation.

Preferably, said vegetable oil and/or said vegetable oil derivative comprises at least 5% by weight, more preferably at least 10% by weight, even more preferably at least 12% by weight of said fatty acid residue comprising unsaturation, based on the total weight of said vegetable oil or said vegetable oil derivative.

Preferably, said vegetable oil and/or said vegetable oil derivative comprises at most 35% by weight, more preferably at most 30% by weight, even more preferably at most 20% by weight of said fatty acid residue comprising unsaturation, based on the total weight of said vegetable oil or said vegetable oil derivative.

Preferably, said vegetable oil and/or said vegetable oil derivative comprises at least 5% by weight and at most 35% by weight, more preferably at least 10% by weight and at most 30% by weight, even more preferably at least 12% by weight and at most 20% by weight of said fatty acid residue comprising unsaturation, based on the total weight of said vegetable oil or said vegetable oil derivative.

Preferably, said fatty acid residue comprising unsaturation is an oleic acid residue.

Preferably, said vegetable oil and/or said vegetable oil derivative also comprises other saturated fatty acid residues, such as palmitic acid and stearic acid residues.

Preferably, said vegetable oil and/or said derivative of a vegetable oil has an iodine value measured in accordance with standard ISO 3961 standard of at least 160, preferably of at least 170, more preferably of at least 175 grams of I₂ per gram of said vegetable oil or said derivative of a vegetable oil.

Preferably, said vegetable oil and/or said derivative of a vegetable oil has an acid value measured in accordance with standard ISO 660 of at most 1, more preferably of at most 2, more preferably of at most 4 mg KOH per g of said vegetable oil or said derivative of a vegetable oil.

Preferably, said vegetable oil and/or said derivative of a vegetable oil has a viscosity measured at 37.8° C. in accordance with standard ASTM D445 of at least 35 mPa·s, more preferably of at least 40 mPa·s. Preferably, said vegetable oil and/or said derivative of a vegetable oil has a viscosity measured at 37.8° C. in accordance with standard ASTM standard D445 of at most 65 mPa·s, more preferably of at most 60 mPa·s, more preferably of at most 55 mPa·s. In a preferred embodiment, said vegetable oil and/or said derivative of a vegetable oil has a viscosity measured at 37.8° C. in accordance with standard ASTM standard D445 of at least 35 and at most 65 mPa·s, more preferably of at least 40 and of at most 60 mPa·s, more preferably of at least 40 and of at most 55 mPa·s.

Preferably, said vegetable oil and/or said derivative of a vegetable oil has a saponification value measured in accordance with standard ISO 3657 of at most 200, more preferably of at most 195 mg KOH per g of said vegetable oil or said derivative of a vegetable oil. Preferably, said vegetable oil and/or said derivative of a vegetable oil has a saponification value measured in accordance with standard ISO 3657 of at least 175, more preferably of at least 170 mg KOH per g of said vegetable oil or said derivative of a vegetable oil. Preferably, said vegetable oil and/or said derivative of a vegetable oil has a saponification value measured in accordance with standard ISO 3657 of at least 175 and of at most 200, more preferably of at least 170 mg and of at most 195 KOH per g of said vegetable oil or said derivative of a vegetable oil.

### The Magnesium Oxide

Preferably, said mixing step further comprises mixing at least 0.1% by weight and at most 75% by weight of magnesium oxide, thus forming the composition (A), based on the total weight of said composition (A).

Preferably, therefore, said method according to the invention comprises at least one mixing step:
of at least 5% by weight and at most 75% by weight of particles of oxygenated zinc compound [hereinafter compound (OZ)], and
of at least 1% by weight and at most 75% by weight of at least one vegetable oil or of at least one vegetable oil derivative,
of at least 0.1% by weight and at most 75% by weight of magnesium oxide, thus forming the composition (A), based on the total weight of said composition (A).

Preferably, at least 0.5% by weight, more preferably at least 0.8% by weight, even more preferably at least 1% by weight of magnesium oxide is mixed in said mixing step.

If desired, at least 5% by weight or at least 10% by weight or at least 20% by weight or at least 30% by weight or at least 40% by weight of magnesium oxide is mixed in said mixing step.

Preferably, at most 75% by weight, more preferably at most 70% by weight, even more preferably at most 60% by weight, even more preferably at most 50% by weight, even more preferably at most 40% by weight, even more preferably at most 30% by weight, even more preferably at most 20% by weight, even more preferably at most 10% by weight of magnesium oxide are mixed in said mixing step.

Preferably, at least 0.5% by weight and at most 7% by weight, more preferably at least 0.5% by weight and at most 5% by weight, even more preferably at least 1% by weight and at most 3% by weight of magnesium oxide are mixed in said mixing step.

### The Calcium Carbonate

Preferably, said mixing step further comprises mixing at least 10% by weight and at most 80% by weight of at least one inorganic base thus forming the composition (A), based on the total weight of said composition (A).

The inventors noticed that the compositions in which the inorganic base was present in the composition according to the invention had an advantageously low angle of repose, which indicates that the composition flows fluidly.

Preferably, the composition according to the present invention has an angle of repose of at most 42°, more preferably of at most 40°, even more preferably of at most 39°, even more preferably of at most 38°, even more preferably of at most 37°.

Preferably, therefore, said method according to the invention comprises at least one mixing step:
of at least 5% by weight and at most 75% by weight of particles of an oxygenated zinc compound [hereinafter compound (OZ)], and
of at least 1% by weight and at most 75% by weight of at least one vegetable oil or of at least one vegetable oil derivative,
of at least 10% by weight and at most 80% by weight of at least one inorganic base, thus forming the composition (A), based on the total weight of said composition (A).

In a preferred embodiment, said method according to the invention comprises at least one mixing step:
of at least 5% by weight and at most 75% by weight of particles of an oxygenated zinc compound [hereinafter compound (OZ)], and
of at least 1% by weight and at most 75% by weight of at least one vegetable oil or of at least one vegetable oil derivative,
of at least 10% by weight and at most 80% by weight of at least one inorganic base,
of at least 0.1% by weight and at most 75% by weight of magnesium oxide, thus forming the composition (A), based on the total weight of said composition (A).

If desired, said at least one inorganic base comprises at least one alkali or alkaline earth cation M, preferably selected from the group consisting of Li⁺, Na⁺, K⁺, Ca²⁺, Mg²⁺ and combinations thereof, and at least one anion A, preferably selected from the group consisting of O²⁻, OH⁻, CO₃²⁻, HCO₃⁻ and combinations thereof.

Preferably, said at least one inorganic base has the formula [M]ₓ[A]_{y} wherein M is an alkali or alkaline earth cation, preferably selected from the group consisting of Li⁺, Na⁺, K⁺, Ca²⁺, Mg²⁺ and combinations thereof and A is an anion, preferably selected from the group consisting of O²⁻OH⁻, CO₃²⁻, HCO₃⁻ and combinations thereof. The coefficients x and y can take the values 1 or 2 or a value between 1 and 2. The value of the x and y coefficients depends on the cation and the anion.

More preferably, said at least one inorganic base is selected from the group consisting of LiOH, NaOH, KOH, Ca(OH)₂, Mg(OH)₂, MgO Li₂CO₃, Na₂CO₃, K₂CO₃, CaCO₃, CaO, MgCO₃, LiHCO₃, NaHCO₃, KHCO₃, Ca(HCO₃)₂, Mg(HCO₃)₂, MgO·CaO and mixtures and/or combinations thereof.

Preferably, said inorganic base is a carbonate.

In the framework of the present invention, the term “carbonate” comprises both compounds comprising the CO₃²⁻ anion and the HCO₃ anion, and therefore also includes hydrogen carbonates and hydroxy carbonates.

Said carbonate may, for example, be CaCO₃, Na₂CO₃, MgCO₃, Al₂(CO₃)₃, NaHCO₃.

Preferably, said carbonate is CaCO₃.

Preferably, at least 13% by weight, more preferably at least 15% by weight, even more preferably at least 17% by weight of inorganic base is mixed in said mixing step.

Preferably, no more than 75% by weight, more preferably no more than 70% by weight, even more preferably no more than 65% by weight of inorganic base is mixed in said mixing step.

Preferably, at least 13% by weight and at most 75% by weight, more preferably at least 15% by weight and at most 70% by weight, even more preferably at least 17% by weight and at most 65% by weight of inorganic base are mixed in said mixing step.

### Other Additives/Fillers

If desired, said mixing step may comprise further mixing at least 10% by weight and at most 80% by weight of at least one filler thus forming the composition (A), based on the total weight of said composition (A).

In the context of the present invention, said filler (I) can be any filler that can be used in a vulcanisation method. The term “filler” does not mean, however, that the filler (I) is inert; in fact, the filler (I) may be a base, for example. It is also possible that the filler (I) may or may not also play a role in the vulcanisation method.

Said filler (I) includes but is not limited to: alumina, silica, hydroxides, silicates, and mixtures thereof.

The silica may include but is not limited to the silica fume or the precipitated silica.

### Use in a Vulcanisation Method

As indicated above, the present invention also relates to a vulcanizing method a vulcanizable composition [composition (C)] comprising, relative to the total weight of the composition (C), the steps of:
providing said composition (C) comprising:
at least one vulcanisable polymer [polymer (V)] with between 2 and 10 parts by weight of said composition (A) according to the invention relative to 100 parts by weight of said polymer (V) and between 0.2 and 15 parts by weight of at least one vulcanising agent [agent (V)] relative to 100 parts by weight of said polymer (V) to form said composition (C).

Preferably, said composition (C) is heated at a temperature and for a time sufficient to obtain a vulcanised composition.

According to the present invention the term “vulcanisable composition” refers to a composition adapted to undergo a vulcanisation reaction as described above.

The mixture of at least one polymer (V) and said composition (A) may comprise other compounds, consequently said composition (C) may also comprise other compounds.

The step of heating said composition (C) may be carried out by means known to those skilled in the art, such as a heating press.

Preferably said composition (C) can be heated to a temperature of at least 120° C., preferably of at least 140° C., more preferably of at least 150° C., more preferably of at least 165° C. If desired, said composition (C) is heated to a temperature of at most 220° C., preferably of at most 200° C., more preferably of at most 180° C.

In a preferred embodiment, said composition (C) is heated to a temperature of between 120° C. and 220° C., more preferably between 160° C. and 200° C., even more preferably between 165° C. and 180° C.

The heating time of said composition (C) must be sufficient to obtain a vulcanised composition. Those skilled in the art can apply the heating times usually used in the state of the art.

### Polymer (V)

The term “vulcanisable polymer” [hereinafter polymer (V)] refers to any type of polymer capable of undergoing a vulcanisation reaction, i.e. capable of being chemically cross-linked during this reaction.

The polymer (V) according to the present invention preferably comprises at least one monomeric unit having at least one unsaturation. This then serves as the active site during the cross-linking. Preferably, the polymer (V) comprises several unsaturations.

The polymer (V) can be, for example, a homopolymer, a copolymer or a terpolymer and can be obtained by polymerisation methods of the Ziegler-Natta or metallocene type, without, however, being limited to the aforementioned polymerisation methods.

Preferably, the polymer (V) can be an elastomer. For example, polymer (V) includes, but is not limited to, natural rubbers, polyisoprene, styrene butadiene (SBR), polybutadiene, isoprene butadiene (IBR), styrene isoprene butadiene (SIBR), ethylene propylene/ethylene propylene diene (EPDM), nitrile elastomers, polymers of propylene oxide polymers, star-branched butyl elastomers, halogenated star-branched butyl elastomers, brominated butyl rubber, chlorinated butyl rubber, cross-linked star-branched polyisobutylene rubber, brominated star-branched butyl polyisobutylene/isoprene copolymer rubber), poly (isobutylene-co-alkylstyrene), preferably isobutylene/methylstyrene copolymers such as isobutylene/meta-bromomethylstyrene, isobutylene/bromomethylstyrene, isobutylene/chloromethylstyrene, isobutylene cyclopentadiene and isobutylene/chloromethylene.

Preferably, the polymer (V) comprises an ethylene repeating unit. Said polymer (V) preferably comprises at least 20% by weight, preferably at least 30% by weight, more preferably at least 40% by weight, even more preferably at least 50% by weight of said ethylene repeating unit relative to the total weight of said polymer (V). Said polymer (V) may preferably comprise at most 95% by weight, more preferably at most 90% by weight, even more preferably at most 85% by weight, even more preferably at most 80% by weight of said ethylene repeating unit relative to the total weight of said polymer (V).

In a preferred embodiment, said polymer (V) comprises between 20% and 95%, preferably between 30% and 90%, more preferably between 40% and 85%, even more preferably between 50% and 80% by weight of said ethylene repeating unit relative to the total weight of said polymer (V).

More preferably, said polymer (V) further comprises a diene repeating unit. Said diene repeating unit includes for example but is not limited to isoprene, butadiene, ethylidene norbornene, dicyclopentadiene, vinyl norbornene and mixtures thereof.

Preferably, the polymer (V) comprises a diene repeating unit. Said polymer (V) preferably comprises at least 0.1% by weight, preferably at least 0.2% by weight, more preferably at least 0.3% by weight, even more preferably at least 0.4%, even more preferably at least 0.5% by weight of said diene repeating unit relative to the total weight of said polymer (V). Said polymer (V) may preferably comprise at most 25% by weight, more preferably at most 20% by weight, even more preferably at most 15% by weight, even more preferably at most 12% by weight of said diene repeating unit relative to the total weight of said polymer (V).

In a preferred embodiment, said polymer (V) comprises between 0.1% and 25%, preferably between 0.2% and 20%, more preferably between 0.3% and 15%, even more preferably between 0.5% and 12% by weight of said diene repeating unit relative to the total weight of said polymer (V).

In another particular embodiment, the polymer (V) is a terpolymer and comprises between 50% and 80% by weight of said ethylene repeating unit and between 0.1% and 25%, preferably between 0.2% and 20%, more preferably between 0.3% and 15%, even more preferably between 0.5% and 12% of said diene repeating unit relative to the total weight of said polymer (V), said diene repeating unit being selected from the group consisting of ethylidene norbornene, dicyclopentadiene, vinyl norbornene and mixtures thereof.

In another alternative embodiment, it may be necessary for the polymer (V) to have a lower percentage by weight of diene, in which case the polymer (V) comprises between 0.1% and 10%, preferably between 0.2% and 9%, more preferably between 0.3% and 8%, even more preferably between 0.5% and 7.5% by weight of said diene repeating unit relative to the total weight of said polymer (V). In this case, the polymer (V) preferably further comprises between 20% and 95%, more preferably between 30% and 90%, more preferably between 40% and 85%, still more preferably between 50% and 80% by weight of said ethylene repeating unit relative to the total weight of said polymer (V), said diene repeating unit being chosen from the group consisting of ethylidene norbornene, dicyclopentadiene, vinyl norbornene and mixtures thereof.

In a still alternative other embodiment, it may be necessary for the polymer (V) to have a greater percentage by weight of diene, in which case the polymer (V) comprises between 1% and 20%, preferably between 2.5% and 17%, more preferably between 5% and 15%, even more preferably between 7% and 12% by weight of said diene repeating unit relative to the total weight of said polymer (V). In this case, the polymer (V) preferably further comprises between 20% and 95%, more preferably between 30% and 90%, more preferably between 40% and 85%, even more preferably between 50% and 80%, even more preferably between 50% and 70%, even more preferably between 50% and 75%, still more preferably between 50% and 70% still more preferably between 50% and 65% by weight of said ethylene repeating unit relative to the total weight of said polymer (V), said diene repeating unit being chosen from the group consisting of ethylidene norbornene, dicyclopentadiene, vinyl norbornene and mixtures thereof.

The polymer (V) may further comprise a propylene repeating unit.

The provision of said composition (C) comprising the mixture of at least one vulcanisable polymer [polymer (V)] with between 2 and 10 parts by weight of said composition (A) relative to 100 parts by weight of said polymer (V). Preferably, the supply of said composition (C) can comprise the mixture of at least one polymer (V) with preferably between 2 and 8 parts by weight, more preferably between 3 and 7 parts by weight, still more preferably between 4 and 6 parts by weight of said composition (A) relative to 100 parts by weight of said polymer (V).

### Additional Component

Preferably, the step of supplying said composition (C) may comprise a step of adding at least one additional component to said polymer (V). Said at least one additional component being selected from the group consisting of diatomaceous earth, quartz, talc, glass filaments, graphite, carbon black, carbon nanotubes and mixtures thereof.

In a preferred embodiment, said at least one additional component is carbon black.

### Oil Phase

Preferably, the step of providing said composition (C) may comprise a step of adding an oily phase to said polymer (V).

The oil phase is liquid at room temperature. Preferably, the oil phase is liquid at a temperature of −20° C., preferably −10° C., preferably −5° C., more preferably 0° C., even more preferably 5° C., even more preferably 10° C., even more preferably at a temperature of 15° C.

If desired, the step of adding an oil phase to said polymer can be carried out before or after said step of adding at least one additional component. Alternatively, the step of adding an oil phase to said polymer can be carried out simultaneously or at least partly simultaneously with said step of adding at least one additional component.

### Vulcanisation Accelerator

Preferably, the step of supplying said composition (C) may comprise further the addition of a vulcanisation accelerator [accelerator (V)].

Any accelerator (V) normally used in vulcanisation methods can be used. In general, the accelerator (V) is chosen from compounds capable of interacting with the activator (V) so as to reduce the vulcanisation time and/or temperature. Preferably, said accelerator is selected from the group consisting of amino aldehydes, guanidines, thiazoles, thiophosphates, sulphenamides, thioureas, thiurams, dithiocarbamates, xanthates and mixtures thereof.

Examples of amino aldehydes include but are not limited to: hexamethylenetetramine, heptaldehyde-aniline condensation products and mixtures thereof. Examples of guanidines include but are not limited to: diphenyl guanidine, N,N′-diorthotolyl guanidine and mixtures thereof.

Examples of thiazoles include but are not limited to: 2-mercaptobenzothiazole, 2-2′-dithiobis(benzothiazole), zinc-2-mercaptobenzothiazole and mixtures thereof. A thiophosphate can, for example, be zinc-O,O-di-N-phosphorodithioate. Sulphenamides include but are not limited to: N-cyclohexyl-2-benzothiazole sulphenamide, N-tert-butyl-2-benzothiazole sulphenamide, 2-(4-morpholinothio)-benzothiazole, N,N′-dicyclohexyl-2-benzothiazole sulphenamide and mixtures thereof. Thioureas include, but are not limited to: ethylene thiourea, di-pentamethylene thiourea, dibutyl thiourea and mixtures thereof. Thiurams include but are not limited to: tetramethylthiuram monosulphide, tetramethylthiuram disulphide, dipentamethylenethiuram tetrasulphide, tetrabenzylthiuram disulphide and mixtures thereof. Dithiocarbamates include but are not limited to: zinc dimethyldithiocarbamate, zinc diethyldithiocarbamate, zinc dibutyldithiocarbamate, zinc dibenzyldithiocarbamate and mixtures thereof. The xanthate may, for example, be zinc isopropyl xanthate.

In a preferred embodiment, said accelerator (V) is selected from the group consisting of mercaptobenzothiazole, tetramethylthiuram disulphide, N-cyclohexyl-2-benzothiazole sulphenamide, zinc dibutyldithiocarbamate and mixtures thereof.

In a more preferred embodiment, said accelerator (V) is a mixture of mercaptobenzothiazole, tetramethylthiuram disulphide, N-cyclohexyl-2-benzothiazole sulphenamide and zinc dibutyldithiocarbamate.

Preferably, at least 0.2 parts by weight, more preferably at least 0.5 parts by weight, even more preferably at least 1 part by weight, even more preferably at least 1.5 parts by weight of said accelerator (V) may be added relative to 100 parts by weight of said polymer (V). If desired, at most 15 parts by weight, more preferably at most 12 parts by weight, still more preferably at most 10 parts by weight of said accelerator (V) may be added relative to 100 parts by weight of said polymer (V).

In one embodiment, between 0.2 and 15 parts by weight, preferably between 0.5 and 12 parts by weight, more preferably between 1 and 10 parts by weight, even more preferably between 1.5 and 10 parts by weight of said accelerator (V) may be added relative to 100 parts by weight of said polymer (V).

### Agent (V)

According to the present invention, the agent (V) is an agent for the vulcanization of the polymer (V). Preferably, the agent (V) is adapted to react with at least one unsaturation of the polymer (V) so as to induce the cross-linking of the latter.

Examples of agents (V) comprise, but are not limited to: sulphur, polysulphides, sulphur monochloride, sulphur dichloride, tellurium, selenium, thiurams, disulphides such as quinonedioximes, organic peroxides, di-isocyanates.

Preferably, the agent (V) is a sulphur compound, and more preferably comprising at least one disulphide (S—S) bond. More preferably, agent (V) is a sulphur compound chosen from the group of sulphur, sulphur chlorides, polysulphides and mixtures thereof.

The inventors have shown that to obtain a vulcanisable composition, the composition (C) must contain at least 0.2 parts by weight of an agent (V) relative to 100 parts by weight of said polymer (V). Preferably, said composition (C) contains at least 0.3 parts by weight, more preferably at least 0.5 parts by weight, of said agent (V) relative to 100 parts by weight of said polymer (V).

The method according to the invention comprises a step of adding 0.2 to 15 parts by weight of at least one vulcanizing agent [agent (V)] relative to 100 parts by weight of said polymer (V) to form said composition (C).

In a preferred embodiment, the method according to the invention comprises a step of adding from 0.2 parts by weight to 4 parts by weight, preferably from 0.3 parts by weight to 3 parts by weight, more preferably from 0.5 parts by weight to 3 parts by weight of said agent (V) relative to 100 parts by weight of said polymer (V).

The agent (V) is advantageously added in the form of a powder to the composition (C).

A final aspect of the present invention concerns a vulcanised composition obtained by the vulcanisation method according to the invention.

### Example—Preparation of a Vulcanization-Activating Composition

ZnO, CaCO₃, linseed oil and MgO were mixed in a mixer. The mixer was fitted with a thermocouple to measure the temperature. All the ingredients were added at the same time in the proportions specified in Table 1. The maximum temperature during mixing and the mixing time are also specified in Table 1.

The unsaturated fatty acid residue composition of the linseed oil used is summarised in Table 2. In addition, the linseed oil used comprises between 5 and 18% by weight of saturated fatty acids relative to the total weight of said linseed oil. The percentages of the various fatty acid residues can be measured using the ISO 12966 standard or any other equivalent standard. ZnO had a D50 of between 1 μm and 100 μm.

TABLE 1

| | | | | | | Maximum | | |
|---|---|---|---|---|---|---|---|---|
| | | | kg | | Specific | temperature | | Angle of |
| | kg | kg | Linseed | kg | surface area | during mixing | Mixing | repose |
| Example | ZnO | CaCO₃ | oil | MgO | (cm²/g) | (° C.) | time | (°) |
| 1 | 40 | 54 | 6 | 0.4 | <0.1 | 30 | 1 min 20 s | — |
| 2 | 40 | 54 | 6 | 0 | 0.6 | 30 | 1 min 30 s | — |
| 3 | 40 | 54 | 6 | 0.4 | 0.2 | 45 | 2 min 30 s | — |
| 4 | 40 | 48 | 12 | 0.4 | <0.1 | 30 | 1 min | — |
| 5 | 40 | 48 | 12 | 0.4 | <0.1 | 45 | 1 min 30 s | — |
| 6 | 40 | 19 | 40 | 1 | — | 30 | 1 min 30 s | — |
| 7 | 40 | 53 | 6 | 1 | <0.1 | 30 | 1 min 30 s | 36 |
| 8 | 93 | 0 | 6 | 1 | <0.1 | 30 | 1 min 30 s | 43 |
| Comp 1 | 100 | 0 | 0 | 0 | >20 | — | — | 50 |

The BET specific surface area was measured on the final composition (A). The specific surface is close to 0, which tends to show that the core of ZnO (and of CaCO₃ and of MgO) is totally or almost totally covered with linseed oil.

TABLE 2

| Unsaturated fatty acid residues | % by weight of total weight of |
|---|---|
| in linseed oil | linseed oil |
| Oleic acid | 16 to 23 |
| Linoleic acid | 12 to 16 |
| α-linolenic acid | 51 to 61 |

The composition obtained in example 4 was not dusty, unlike the other compositions obtained in examples 1, 2, 3 and 5.

The compositions of examples 1 to 5 and 7 were powder compositions in which ZnO, CaCO₃ and MgO were the majority constituents of a core at least partially covered with a layer of linseed oil. The composition in example 6 was a pasty composition.

The composition according to example 8 was a powder composition in which ZnO and MgO were the majority constituents of a core at least partially covered by a layer of linseed oil.

The angle of repose is smaller for example 7 than for example 8. The angle of repose is smaller for example 8 than for comparative example 1.

Those skilled in the art know how to measure the angle of repose. For example, a defined volume (for example 150 ml) of a composition whose angle of repose is to be measured is taken and placed in a funnel placed above and in the centre of a flat-bottomed cylinder. For example, the funnel outlet can be 7.5 cm from the top of the cylinder. The entire defined volume is allowed to flow. Once the entire product has run out, the height in mm of the pyramid formed is measured. Using a trigonometric formula, the angle at the base of the pyramid is measured and is known as the angle of repose.

### Example—Use of Compositions of Compositions (A) in a Vulcanisation Method

Each of the compositions (A) obtained in examples 2, 3, 4 and 6 was mixed in a mixer with ingredients whose nature and proportions are listed in table 3.

TABLE 3

| Compounds added for the vulcanisation | Shares by weight |
|---|---|
| Natural rubber (TSR10) | 80 |
| Cis 1,4 polybutadiene (BR1220) | 20 |
| Carbon black (N347) | 55 |
| Naphtha oil | 7 |
| N-(1,3-dimethylbutyl)-N′-phenyl-p-phenylenediamine | 2 |
| 2,2,4-Trimethyl-1,2-Dihydroquinoline (TMQ) | 1 |
| Cyclohexyl-benzothiazole sulphonamide (CBS) | 0.8 |
| Sulphide | 2.3 |
| Stearic acid | 2.5 |
| Composition (A) of examples 2, 3, 4 and 6 | 5 |

The mechanical properties of vulcanised rubbers are listed in Table 4. The same method was repeated with ZnO in place of the composition (A) of examples 2, 3, 4 and 6, this being the “ZnO” example (comparative example).

TABLE 4

| Example | ZnO | 2 | 3 | 4 | 6 |
|---|---|---|---|---|---|
| Cmin (dNm) | 2.72 | 2.4 | 2.4 | 2.6 | 2.59 |
| Cmax(dNm) | 21.40 | 18.4 | 19.1 | 18.3 | 17.77 |
| TR (min) | 18.69 | 16.1 | 16.7 | 15.8 | 15.18 |
| Ts2 (min) | 1.00 | 0.87 | 0.91 | 0.96 | 1.10 |
| T50 (min) | 1.55 | 1.35 | 1.42 | 1.47 | 1.58 |
| T90 (min) | 2.80 | 2.31 | 2.41 | 2.47 | 2.63 |
| R/R (Mpa) | 19.2 | 19.7 | 20.7 | 20.5 | 20.5 |
| Hardness (Sh-A) | 65 | 61 | 60.5 | 59 | 59 |
| Tear (KN/m) | 202 | 205 | 181 | 206 | 206 |

The oscillating disc rheometer can be used to determine the duration of a vulcanisation by measuring the vulcanisation start-up time (Ts2) and the time associated with the end of the vulcanisation (t90). Maximum torque (Cmax) measured during the rheological test can be used to determine the ts2 and t90 values. The variation in torques gives an indication of the degree of cross-linking of the product obtained after the vulcanisation. All the rheometry measurements were taken at a temperature of 170° C.

The maximum torque corresponds to the measurement of the vulcanised (cured) product. Indeed, to maintain stable oscillation of the rheometer disc in terms of both frequency and amplitude, the device's motor supplies what is known as a variable torque. The latter depends on the elasticity/viscosity of the product tested. So the more viscous or elastic the product, the higher the torque.

Measurements of Cmin, Cmax, TR, Ts2, T50 and T90 were taken with an oscillating disc rheometer in accordance with standard ASTM D5289 at a temperature of 170° C.

The R/R (breaking strength) was measured in accordance with standard NF T 46-002.

The hardness measurements (SH-A hardness) were carried out in accordance with standard ISO7619-1 2010.

The tear measurements were carried out in accordance with standard NF T 46-007.

As can be seen, the mechanical properties of the different examples are comparable, which tends to show that the presence of vegetable oil has no or negligible influence on the mechanical properties of vulcanised polymers.

### Zinc Release Tests

Zinc release tests were carried out on rubbers obtained after vulcanisation using the composition (a) of example 6 and ZnO (comparative example).

For each rubber sample, a piece measuring 10 cm by 8 cm was cut out. Each piece of rubber was divided and cut into about twenty small squares measuring 2 cm by 2 cm. Each small square was weighed. Each small square was successively cleaned 3 times in 3 aluminium dishes with milli-Q water.

After rinsing, the small squares were placed directly into 250 ml glass bottles and covered with 200 ml milli-Q water. The bottles were closed with plugs. A bottle was filled with Milli-Q water for reference.

Each bottle was placed in an oven at 35° C. and shaken every day for 4 weeks. A sample of each bottle was taken at regular intervals and analysed by atomic absorption in accordance with standard FD T 90-112. The results of the bottle water analyses are shown in table 5.

TABLE 5

| | ZnO (comparative | Composition(A) |
|---|---|---|
| Zn content in water | example) | example 6 |
| After 1 week | 1.74 mg/L | 0.17 mg/L |
| After 2 weeks | 2.8 mg/L | 0.13 mg/L |
| After 4 weeks | 3.22 mg/L | 0.15 mg/L |

As can be seen, the amount of ZnO released by the rubber resulting from the vulcanisation using the composition (A) of example 6 releases very little ZnO, and the amount of ZnO released does not appear to change over time. The opposite is observed when standard ZnO is used for the vulcanisation.

1-30. (canceled)

31. A method for preparing a vulcanization-activating composition [hereinafter, composition (A)], said method comprising at least one mixing step:
at least 5% by weight and at most 95% by weight, preferably at least 5% by weight and at most 75% by weight, of particles of an oxygenated zinc compound [hereinafter compound (OZ)]; and
of at least 1% by weight and at most 75% by weight of at least one vegetable oil or of at least one vegetable oil derivative, thus forming the composition (A), the percent by weight being based on the total weight of said composition (A),
wherein said vegetable oil or vegetable oil derivative comprises, based on the total weight of said vegetable oil or vegetable oil derivative: at least 8% by weight of at least one fatty acid residue; said fatty acid residue comprising at least two unsaturations.

32. The method according to claim 31, wherein said mixing step further comprises mixing at least 0.1% by weight and at most 75% by weight of magnesium oxide, based on the total weight of said composition (A).

33. The method according to claim 31, in which said mixing step additionally comprises mixing at least 10% by weight and at most 80% by weight of at least one inorganic base, based on the total weight of said composition (A).

34. The method according to claim 31, wherein said vegetable oil derivative is a derivative of an oil selected from the group consisting of linseed oil, walnut oil, sunflower oil, corn oil, avocado oil, hemp oil, grapeseed oil, olive oil, peanut oil, rice oil, sesame oil, soya oil, rapeseed oil, safflower oil, wheat germ oil, palm oil and mixtures thereof.

35. The method according to claim 31, wherein said vegetable oil and/or said vegetable oil derivative comprises at least 15% by weight of said fatty acid residue, more preferably at least 20% by weight of said fatty acid residue, more preferably at least 25% by weight of said fatty acid residue, more preferably at least 30% by weight of said fatty acid residue, more preferably at least 35% by weight of said fatty acid residue, even more preferably at least 40% by weight of said fatty acid residue, even more preferably at least 50% by weight of said fatty acid residue, based on the total weight of said vegetable oil or said vegetable oil derivative and wherein said vegetable oil and/or said vegetable oil derivative comprises at most 80% by weight of said fatty acid residue, more preferably at most 75% by weight of said fatty acid residue, even more preferably at most 70% by weight of said fatty acid residue, based on the total weight of said vegetable oil or said vegetable oil derivative.

36. The method according to claim 31, wherein said fatty acid residue is a residue selected from the group consisting of α-linolenic acid, γ-linolenic acid, dihomo-γ-linolenic acid, arachidonic acid, eicosapentaenoic acid, docosahexaenoic acid and linoleic acid residues.

37. The method according to claim 31, wherein said fatty acid residue is a fatty acid residue (A) comprising two unsaturations and said vegetable oil and/or said vegetable oil derivative further comprises a fatty acid residue (B) comprising at least three unsaturations.

38. The method according to claim 31, wherein said fatty acid residue (A) is a linoleic acid residue and said fatty acid residue (B) is a residue selected from the group consisting of α-linolenic acid, γ-linolenic acid, dihomo-γ-linolenic acid, arachidonic acid, eicosapentaenoic acid and docosahexaenoic acid residues and linoleic acid.

39. The method according to claim 31, wherein at least 10% by weight of said compound (OZ), more preferably at least 12% by weight, more preferably at least 15% by weight, more preferably at least 20% by weight, more preferably at least 25% by weight, more preferably at least 30% by weight, more preferably at least 40% by weight, more preferably at least 50% by weight, more preferably at least 60% by weight of said compound (OZ) based on the total weight of said composition (A) are mixed in said mixing step and wherein at most 70% by weight of said compound (OZ), more preferably at most 65% by weight, more preferably at most 55% by weight, more preferably at most 50% by weight, more preferably at most 45% by weight, more preferably at most 40% by weight, more preferably at most 35% by weight of said compound (OZ) based on the total weight of said composition (A), are mixed in said mixing step.

40. The method according to claim 31, in which said composition (A) is a pasty or liquid composition, said method comprising at least one mixing step:
of at least 20% by weight and at most 60% by weight of particles of a compound (OZ); and
of at least 15% by weight and at most 75% by weight of at least one vegetable oil or of at least one vegetable oil derivative, thus forming the composition (A),
based on the total weight of said composition (A).

41. The method according to claim 31, in which said composition (A) is a pulverulent composition of at least partially coated OZ compound particles, said method comprising at least one mixing step:
of at least 20% by weight and at most 60% by weight of particles of a compound (OZ); and
of at least 1% by weight and at most 35% by weight of at least one vegetable oil or of at least one vegetable oil derivative, thus forming the composition (A),
based on the total weight of said composition (A).

42. The method according to claim 32, wherein at least 0.5% by weight, more preferably at least 0.8% by weight, even more preferably at least 1% by weight of magnesium oxide is mixed in said mixing step.

43. The method according to claim 32, in which at most 75% by weight, more preferably at most 70% by weight, even more preferably at most 60% by weight, even more preferably at most 50% by weight, even more preferably at most 40% by weight, even more preferably at most 30% by weight, even more preferably at most 20% by weight, even more preferably at most 10% by weight of magnesium oxide are mixed in said mixing step.

44. The method according to claim 33, wherein said at least one inorganic base is selected from the group consisting of at least one inorganic base selected from the group consisting of LiOH, NaOH, KOH, Ca(OH)₂, Mg(OH)₂, MgO Li₂CO₃, Na₂CO₃, K₂CO₃, CaCO₃, CaO, MgCO₃, LiHCO₃, NaHCO₃, KHCO₃, Ca(HCO₃)₂, Mg(HCO₃)₂, MgO·CaO and their mixtures and/or combinations.

45. A method for vulcanizing a vulcanizable composition [composition (C)] comprising, relative to the total weight of the composition (C), the step of:
providing said composition (C) comprising:
at least one vulcanizable polymer [polymer (V)] with between 2 and 10 parts by weight of said composition (A) obtained by the method according to claim 31 relative to 100 parts by weight of said polymer (V) and between 0.2 and 15 parts by weight of at least one vulcanizing agent [agent (V)] relative to 100 parts by weight of said polymer (V) to form said composition (C).
